(19) United States
(12) Patent Application Publication
(10) Pub. No.: US 2026/0287246 A1
(43) Pub. Date: Sep. 24, 2026

(54) REFRIGERATOR AND METHOD FOR CONTROLLING THE SAME

(71) Applicant: SAMSUNG ELECTRONICS CO., LTD., Suwon-si (KR)

(72) Inventors: Yongchan KWON, Suwon-si (KR); Jongsoo HONG, Suwon-si (KR); Jihyun RYU, Suwon-si (KR); Taegyoon NOH, Suwon-si (KR); Chunseong KIM, Suwon-si (KR)

(73) Assignee: SAMSUNG ELECTRONICS CO., LTD., Suwon-si (KR)

(21) Appl. No.: 19/535,749

(22) Filed: Feb. 10, 2026

Related U.S. Application Data
(63) Continuation of application No. PCT/KR2026/001374, filed on Jan. 23, 2026.

(30) Foreign Application Priority Data
Mar. 18, 2025 (KR) 10-2025-0034936

(51) Int. Cl. F25D 23/02; E05F 15/611; F25D 29/00

(52) U.S. Cl. CPC F25D 23/028; E05F 15/611; F25D 29/00; E05Y 2900/31; F25D 2700/02; F25D 2700/04

(57) ABSTRACT

A refrigerator, includes: a main body forming a storage compartment; a door rotatably coupled to the main body and configured to open and configured to close the storage compartment; a door sensor configured to detect opening of the door at an angle relative to the main body; a door driving device configured to open and configured to close the door; and a controller configured to: control the door driving device to close the door based on a condition to close the door being satisfied in an automatic mode, maintain the opening of the door at the angle relative to the main body based on the condition to close the door being satisfied in a manual mode, and change the automatic mode to the manual mode, based on the door sensor detecting the opening of the door being at the angle relative to the main body.

### CROSS REFERENCE TO THE RELATED APPLICATION

This application is a continuation application, filed under 35 U.S.C. § 111(a), of International Application PCT/KR2026/001374, filed Jan. 23, 2026, and is based on and claims priority under 35 U.S.C. § 119 to Korean Patent Applications No. 10-2025-0034936, filed on Mar. 18, 2025 in the Korean Intellectual Property Office, the disclosures of which are incorporated by reference herein in their entireties.

### TECHNICAL FIELD

The disclosure relates to a refrigerator capable of automatically opening and closing a door, and a method for controlling the same.

### BACKGROUND ART

A refrigerator is an appliance that includes a main body with a storage compartment, and a cold air supply system for supplying cold air to the storage compartment so as to keep food fresh. The storage compartment may include a refrigerating compartment maintained at approximately 0 to 5 °C to store food in a refrigerated manner, and a freezing compartment maintained at approximately 0 to −30 °C to store food in a frozen manner. The front of the storage compartment may be opened to put food in or take the food out.

The refrigerator includes a door for opening or closing a storage compartment. The door is rotatable with respect to a main body to open and close the storage compartment.

The door is configured to allow a user to open and close the door by holding a handle provided on the door and rotating the door relative to the main body. Alternatively, the refrigerator may include a door opening/closing structure configured to allow the door to be easily opened or closed.

### DISCLOSURE

An aspect of the disclosure provides a refrigerator that may improve user convenience by changing whether to automatically close a door according to the user's intent, and a method for controlling the refrigerator.

Technical aspects that can be achieved by the disclosure are not limited to the above-mentioned aspects, and other technical aspects not mentioned will be clearly understood by one of ordinary skill in the technical art to which the disclosure belongs from the following description.

According to an aspect of the disclosure, a refrigerator may include: a main body forming a storage compartment; a door rotatable to open and close the storage compartment; a door sensor configured to detect an opening angle of the door; a door driving device configured to open and close the door; and a controller configured to: in an automatic mode, control the door driving device to close the door based on a defined closing condition being satisfied, in a manual mode, maintain the door open even based on the defined closing condition being satisfied, and change the automatic mode to the manual mode, based on a first angle condition being detected by the door sensor while the door is open.

According to an aspect of the disclosure, in a method for controlling a refrigerator including a main body forming a storage compartment; a door rotatable to open and close the storage compartment; a door sensor configured to detect an opening angle of the door; and a door driving device configured to open and close the door, the method may include: detecting whether the door is open; detecting, by the door sensor, a change in the opening angle of the door; and based on a first angle condition being detected by the door sensor, changing an automatic mode to a manual mode, the automatic mode in which the door driving device is controlled to close the door based on a defined closing condition being satisfied, and the manual mode in which the door is maintained open even based on the defined closing condition being satisfied.

According to an aspect of the disclosure, a refrigerator may include: a main body forming a storage compartment; a door rotatably coupled to the main body and configured to open and configured to close the storage compartment; a door sensor configured to detect opening of the door at an angle relative to the main body; a door driving device configured to open and configured to close the door; and a controller configured to: control the door driving device to close the door based on a condition to close the door being satisfied in an automatic mode, maintain the opening of the door at the angle relative to the main body based on the condition to close the door being satisfied in a manual mode, and change the automatic mode to the manual mode, based on the door sensor detecting the opening of the door being at the angle relative to the main body.

According to an aspect of the disclosure, a method for controlling a refrigerator may include: detecting a door, the door being rotatably connected to a main body forming a storage compartment and the door is configured to open and configured to close the storage compartment, is open; detecting, by a door sensor configured to detect an opening of the door at angle relative to the main body, a change in the angle relative to the main body; and based on the opening of the door at the angle relative to the main body being detected by the door sensor changing an automatic mode of a door driving device configured to open and configured close the door, to a manual mode of the door driving device, wherein in the automatic mode, the door driving device is controlled to close the door based on a condition being satisfied, and in the manual mode, the door is maintained open based on the condition being satisfied.

### DESCRIPTION OF DRAWINGS

FIG. 1 is a perspective view of a refrigerator according to an embodiment of the disclosure.

FIG. 2 is a control block diagram of a refrigerator according to an embodiment of the disclosure.

FIG. 3 illustrates automatic and manual closing modes of a door according to an embodiment of the disclosure.

FIG. 4 is a flowchart illustrating a method for controlling a refrigerator according to an embodiment of the disclosure.

FIGS. 5A, 5B, 5C, 5D, 5E, and 5F illustrates various output values of a door sensor according to an embodiment of the disclosure.

FIG. 6 is a flowchart illustrating operation of changing to an automatic mode as a door is closed according to an embodiment of the disclosure.

FIG. 7 is a flowchart illustrating operation of automatic door closing in a manual mode according to an embodiment of the disclosure.

FIG. 8 is a flowchart illustrating operation of changing an automatic door closing condition according to an embodiment of the disclosure.

FIG. 9 is a flowchart illustrating operation of providing a notification according to an embodiment of the disclosure.

FIG. 10 is a flowchart illustrating operation of changing a door closing mode through a user interface according to an embodiment of the disclosure.

FIG. 11 is a flowchart illustrating operation of changing an automatic door closing condition through a user interface according to an embodiment of the disclosure.

### MODES OF THE DISCLOSURE

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of any element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A refrigerator according to an embodiment of the disclosure may include a main body.

The “main body” may include an inner case, an outer case positioned outside the inner case, and an insulation provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate an inside of the storage compartment from an outside of the storage compartment to maintain inside temperature of the storage compartment at appropriate temperature without being influenced by an external environment of the storage compartment. According to an embodiment of the disclosure, the insulation may include a foaming insulation. The foaming insulation may be molded by fixing the inner case and the outer case with jigs, etc., and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a foaming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulation.

The storage compartment may be maintained within an appropriate temperature range according to a purpose of use, and may include a “refrigerating compartment”, a “freezing compartment”, and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of −20 degrees Celsius to −1 degrees Celsius. The temperature conversion compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below are to be understood as representing storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulation to insulate the storage compartment in a closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

The refrigerator according to an embodiment of the disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to an embodiment of the disclosure may include a controller for controlling the refrigerator.

The “controller” may include a memory for storing and/or recording data and/or programs for controlling the refrigerator, and a processor for outputting control signals for controlling the cold air supply device, etc., in accordance with the programs and/or data stored in the memory.

The memory may store or record various information, data, instructions, programs, and the like necessary for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data recorded/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with to an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, a refrigerator according to various embodiments of the disclosure will be described in detail with reference to the accompanying drawings.

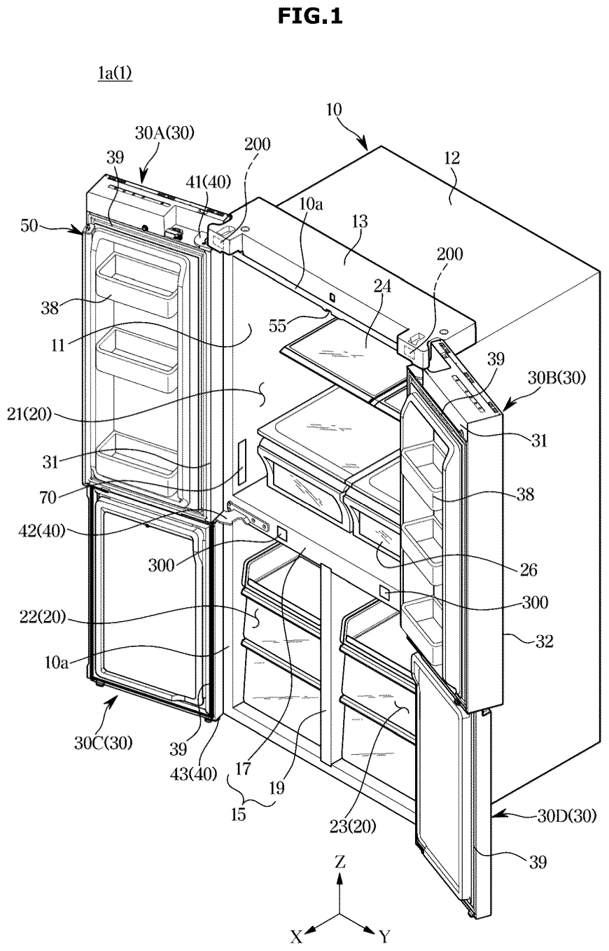

FIG. 1 is a perspective view of a refrigerator according to an embodiment of the disclosure.

FIG. 1 is a perspective view of a refrigerator according to an embodiment of the disclosure.

Referring to FIG. 1, a refrigerator 1a according to an embodiment of the disclosure may include a main body 10, a storage compartment 20 inside the main body 10, a door 30 for opening and closing the storage compartment 20, and a cooling system for supplying cold air to the storage compartment 20.

The main body 10 may include an inner case 11 forming the storage compartment 20 and an outer case 12 forming an exterior of the refrigerator 1a. The outer case 12 may be formed to have a shape of a box with a substantially open front. The outer case 12 may form an upper surface, a lower surface, left and right side surfaces, a rear surface, and the like of the refrigerator 1a. The inner case 11 may be open at the front. The inner case 11 may have the storage compartment 20 therein and may be provided inside the outer case 12. An inner wall of the inner case 11 may form an inner wall of the storage compartment 20.

A main body insulation may be provided between the outer case 12 and the inner case 11 of the main body 10 to insulate the outer case 12 and the inner case 11. The main body insulation may be foamed between the inner case 11 and the outer case 12 to couple the inner case 11 and the outer case 12 to each other. The main body insulation may prevent heat exchange from occurring between the inside of the storage compartment 20 and the outside of the main body 10, thereby improving the cooling efficiency inside the storage compartment 20. As the main body insulation of the main body 10, urethane foam insulation, expanded polystyrene (EPS) insulation, a vacuum insulation panel, or the like may be used. However, the disclosure is not limited thereto, and the main body insulation may be configured to include various materials.

The main body 10 may further include a top table 13 located on an upper portion of the main body 10. The top table 13 may be coupled to the upper portion of the outer case 12. The top table 13 may be coupled to an upper side of the outer case 12. The top table 13 may cover a portion of the upper side of the outer case 12.

The top table 13 may cover various electronic components. An accommodation space for accommodating various electronic components may be formed in the top table 13. For example, the top table 13 may cover a door driving device 100 to be described later, and the door driving device 100 may be accommodated in the top table 13.

The storage compartment 20 may be provided inside the main body 10. For example, the storage compartment 20 may include a refrigerating compartment maintained at approximately 0 to 5 degrees Celsius to store food in a refrigerated state. For example, the storage compartment 20 may include a freezing compartment maintained at approximately minus 23 to minus 17 degrees Celsius to store food in a frozen state.

For example, the storage compartment 20 may be divided into a plurality of areas by a partition 15. Specifically, the storage compartment 20 may be divided into an upper first storage compartment 21 and lower storage compartments 22 and 23 by a first partition 17 extending in a horizontal direction Y. In addition, the lower storage compartments 22 and 23 of the storage compartment 20 may be divided into the left second storage compartment 22 and the right third storage compartment 23 by a second partition 19 extending in a vertical direction Z. Here, for example, the first storage compartment 21 may be used as a refrigerating compartment, and the second storage compartment 22 and the third storage compartment 23 may both be used as freezing compartments. Alternatively, one of the second storage compartment 22 and the third storage compartment 23 may be used as a freezing compartment and the other may be used as a refrigerating compartment.

The division method of the storage compartment 20 described above and the use of each of the divided storage compartments 21, 22, and 23 are merely an example and are not limited thereto.

Inside the storage compartment 20, a shelf 24 on which food may be placed and a storage container 26 for storing food may be provided.

The refrigerator 1a may include a cooling system to generate cold air using a cooling cycle and supply the generated cold air to the storage compartment 20. The cooling system may generate cold air using a refrigeration circulation cycle that compresses, condenses, expands, and evaporates refrigerant. For example, the cooling system may include a compressor, a condenser, an expansion valve, an evaporator, a blowing fan, and the like. The cold air generated by the cooling system may be supplied to the storage compartment 20 through a cold air supply duct formed at a rear portion of the inner case 11.

The door 30 may open and close the storage compartment 20. The door 30 may open and close an opening formed on one side of the main body 10. The door 30 may be rotatable with respect to the main body 10.

An outer side of the door 30 may form a part of the exterior of the refrigerator 1a. In a position where the door 30 is closed, the outer side of the door 30 may form at least a part of the front exterior of the refrigerator 1a. In a state where the door 30 is closed, an inner side of the door 30 may face the inside of the storage compartment 20. The inner side of the door 30 refers to one surface of the door 30 that faces the storage compartment 20 while the door 30 is closing the storage compartment 20. The inner side of the door 30 may be referred to as a rear side 31 of the door. In addition, the outer side of the door 30 refers to the other surface opposite to the inner side of the door 30 that faces the storage compartment 20 while the door 30 is closing the storage compartment 20. The outer side of the door 30 may be referred to as a front side 32 of the door.

A basket 38 for storing food may be disposed on the rear side 31 of the door 30.

A gasket 39 may be provided on the rear side 31 of the door 30 to seal the gap between the door 30 and the main body 10 in order to prevent the cold air of the storage compartment 20 from leaking. The gasket 39 will be described in more detail below.

The refrigerator 1a may include an upper door and a lower door arranged parallel to each other in the vertical direction Z. The refrigerator 1a may include a left door and a right door arranged parallel to each other in the horizontal direction Y. The refrigerator 1a may include a plurality of doors 30A, 30B, 30C, and 30D for opening and closing each of the divided storage compartments 21, 22, and 23.

The first storage compartment 21 may be opened and closed by a pair of upper doors 30A and 30B. The refrigerator 1a may include the first door 30A that opens and closes a portion of the first storage compartment 21, and the second door 30B that opens and closes another portion of the first storage compartment 21. The first door 30A and the second door 30B may be rotatable independently of each other with respect to the main body 10. The first door 30A and the second door 30B may be arranged parallel to each other in the horizontal direction Y. For example, the first door 30A may open and close a left portion of the first storage compartment 21, and the second door 30B may open and close a right portion of the first storage compartment 22.

A rotating bar 50 may be provided on one of the pair of upper doors 30A and 30B (for example, the first door 30A). The rotating bar 50 may be rotatable with respect to the one door and may cover a gap between the pair of upper doors 30A and 30B when the pair of upper doors 30A and 30B closes the first storage compartment 21.

The second storage compartment 22 may be opened and closed by the left lower door 30C. The refrigerator 1a may include the third door 30C provided to open and close the second storage compartment 22. The third door 30C may be rotatable with respect to the main body 10. For example, the first door 30A and the third door 30C may be arranged parallel to each other in the vertical direction Z.

The third storage compartment 23 may be opened and closed by the right lower door 30D. The refrigerator 1a may include the fourth door 30D provided to open and close the third storage compartment 23. The fourth door 30D may be rotatable with respect to the main body 10. For example, the second door 30B and the fourth door 30D may be arranged parallel to each other in the vertical direction Z. In addition, the third door 30C and the fourth door 30D may be arranged parallel to each other in the horizontal direction Y.

A handle may be provided on each of the plurality of doors 30A, 30B, 30C, and 30D. A user may open or close each of the doors 30A, 30B, 30C, and 30D by holding the handle provided on each of the plurality of doors 30A, 30B, 30C, and 30D. In other words, a user may open or close each storage compartment 21, 22, and 23 by holding the handle provided on each of the plurality of doors 30A, 30B, 30C, and 30D. For example, the handle provided on each of the plurality of doors 30A, 30B, 30C, and 30D may have a groove concavely formed to be gripped.

The refrigerator 1a may include a hinge 40 that connects the main body 10 and the door 30. The hinge 40 may allow the door 30 to be rotatable with respect to the main body 10. The hinge 40 may be fixed to the main body 10. Specifically, the hinge 40 may be coupled to the outer case 12.

The hinge 40 may rotatably support the door 30. The door 30 may be rotatably coupled to the main body 10 by the hinge 40.

Specifically, the refrigerator 1a may include a plurality of hinges 41, 42, and 43 to support the plurality of doors 30A, 30B, 30C, and 30D, respectively. For example, the refrigerator 1a may include a pair of upper door hinges 41 coupled to an upper portion of the main body 10 to rotatably support the first door 30A and the second door 30B, respectively. In addition, for example, the refrigerator 1a may include a pair of lower door hinges 43 coupled to a lower portion of the main body 10 to rotatably support the third door 30C and the fourth door 30D, respectively. In addition, for example, the refrigerator 1a may include a pair of middle hinges 42 disposed between the upper door hinge 41 and the lower door hinge 43, and coupled to a middle portion of the main body 10 (specifically, to the first partition 17) to rotatably support each of the first door 30A, the second door 30B, the third door 30B, and the fourth door 30D.

The refrigerator 1a may include the rotating bar 50. The rotating bar 50 may be provided to cover a gap between the first door 30A and the second door 30B when the first door 30A and the second door 30B close the first storage compartment 21. The rotating bar 50 may be rotatably coupled to the first door 30A. The rotating bar 50 may be formed in the shape of a bar that is elongated along the vertical direction Z of the first door 30A.

The refrigerator 1a may include a rotation guide 55 provided to guide the movement of the rotating bar 50. The rotation guide 55 may guide the movement of the rotating bar 50 when the first door 30A rotates between an open position and a closed position. The rotation guide 55 may include a groove structure formed such that a part of the rotating bar 50 is inserted and moved. The rotation guide 55 may be mounted on the main body 10. Specifically, the rotation guide 55 may be mounted on an upper portion of the inner case 11.

The refrigerator 1a may include the door driving device 100 provided to open/close the door 30. The door driving device 100 may be provided on the main body 10. The door driving device 100 may be mounted on the main body 10. The door driving device 100 may be installed on the main body 10. For example, a plurality of door driving devices 100 may be provided. The number and shape of the door driving devices 100 may vary, and may be provided at various positions depending on the number and type of the doors 30.

The refrigerator 1a may include a door sensor 200. The door sensor 200 may detect an opening angle of the door 30. The door sensor 200 may detect a change in the opening angle of the door 30. A plurality of door sensors 200 may be provided. For example, the door sensor 200 may be provided around the hinge, and may output a corresponding output value according to the rotation of the door 30. Although only two door sensors 200 are shown in the drawing, the disclosure is not limited thereto. The number and shape of the door sensors 200 may vary, and may be provided at various positions depending on the number and type of the doors 30.

In addition, the refrigerator 1a may include an object sensor 300. The object sensor 300 may be provided around the horizontal partition 17, and may detect a person around the door. Although only two object sensors 300 are shown in the drawing, the disclosure is not limited thereto. The number and shape of the object sensors 300 may vary, and may be provided at various positions depending on the number and type of the doors 30.

In addition, the refrigerator 1a may include a user interface 70. The user interface 70 may include an input interface 71 for receiving a user input. The user interface 70 may include an output interface 72 for displaying information related to the operation of the refrigerator 1. According to various embodiments, the user interface 70 may be implemented as a control panel.

The above-described components of the refrigerator 1a with reference to FIG. 1 is merely an example, and the disclosure is not limited thereto. The refrigerator according to the disclosure may include various components for supplying cold air to the storage compartment to store food.

The type of refrigerator to which the refrigerator according to the disclosure is applied is not limited to the refrigerator 1a shown in the drawings, and the refrigerator according to the disclosure may include various types of refrigerators, such as a French Door type, Side-by-side type, Bottom Mounted Freezer (BMF) type, Top Mounted Freezer (TMF) type, and the like.

Furthermore, although the refrigerator 1a according to an embodiment of the disclosure has been described as an example of the disclosure with an assumption that the refrigerator is an indirect cooling refrigerator, the disclosure is not limited thereto and may also be applied to a direct cooling refrigerator.

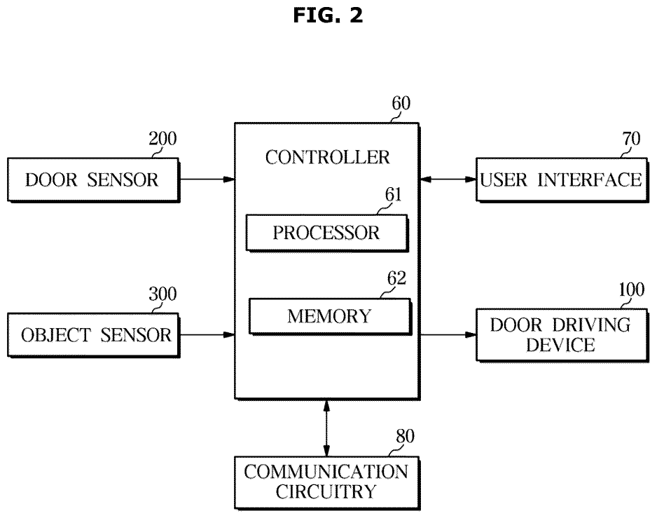

FIG. 2 is a control block diagram of a refrigerator according to an embodiment of the disclosure.

Referring to FIG. 2, the refrigerator 1 according to an embodiment may include a controller 60, the user interface 70, communication circuitry 80, the door driving device 100, the door sensor 200, and the object sensor 300.

The door sensor 200 may detect an opening angle of the door 30. The door sensor 200 may detect a change in the opening angle of the door 30.

The object sensor 300 may detect a person around the door 30.

The door driving device 100 may open/close the door 30.

The user interface 70 may include the input interface 71 for receiving a user input. The user interface 70 may include the output interface 72 for displaying information related to the operation of the refrigerator 1. According to various embodiments, the user interface 70 may be implemented as a control panel.

The input interface 71 may include various input devices, such as a tact switch, a push switch, a slide switch, a toggle switch, a micro switch, a touch switch, a touch screen, or a button.

The output interface 72 may be implemented as various types of known displays, such as a liquid crystal display (LCD), a light emitting diode (LED), a plasma display panel (PDP), an organic light emitting diode (OLED), a cathode ray tube (CRT), but is not limited thereto. Any device that may visually display various information about the refrigerator 1 and display a user interface for receiving various control commands from a user may be used as the output interface 72.

The refrigerator 1 may display, on the output interface 72, a user interface implemented to provide various information to a user and receive various control commands related to the refrigerator 1 from the user.

The refrigerator 1 may include the communication circuitry 80 for communicating with an external device (e.g., a server, a user device, and/or another home appliance) by wire and/or wirelessly.

The communication circuitry 80 may include at least one of a short-range wireless communication module or a long-range wireless communication module.

The communication circuitry 80 may transmit data to an external device or receive data from an external device. For example, the communication circuitry 80 may establish communication with a server, a user device, and/or another home appliance, and may transmit and receive various data.

For the communication, the communication circuitry 80 may establish a direct (e.g., wired) communication channel or a wireless communication channel between the external devices, and support the performance of the communication through the established communication channel. According to an embodiment, the communication circuitry 80 may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or wide area network WAN)). These various types of communication modules may be integrated as a single component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an IrDA communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include mobile communication circuitry. The mobile communication circuitry transmits and receives radio signals with at least one of a base station, an external terminal, and a server in a mobile communication network.

The communication circuitry 80 may communicate with an external device through a nearby access point (AP). The AP may connect a LAN, to which the refrigerator 1 is connected, to a WAN to which a server is connected. The refrigerator 1 may be connected to the server via a WAN.

The controller 60 may be electrically connected to various components and/or devices of the refrigerator, and may control the various components and/or devices of the refrigerator, such as the user interface 70, the communication circuitry 80, and the door driving device 100. For example, the user interface 70, the communication circuitry 80, and the door driving device 100 may be operated based on a control signal from the controller 60.

The controller 60 may include a processor 61 that generates a control signal related to the operation of the refrigerator 1. The controller 60 may include a memory 62 that stores programs, applications, instructions, and/or data for the operation of the refrigerator 1. The processor 61 and the memory 62 may be implemented as separate semiconductor devices or as a single semiconductor device. In addition, the controller 60 may include a plurality of processors 61 or a plurality of memories 62. The controller 60 may be disposed at various positions inside the refrigerator 1. For example, the controller 60 may be included in a printed circuit board provided inside a control panel.

The processor 61 may include an arithmetic circuit, a storage circuit, and a control circuit. The processor 61 may include a single chip or a plurality of chips. In addition, the processor 61 may include a single core or a plurality of cores.

The memory 62 may include volatile memory, such as static random access memory (S-RAM) and dynamic random access memory (D-RAM), and non-volatile memory, such as read only memory (ROM) and erasable programmable read only memory (EPROM), The memory 62 may include a single memory device or a plurality of memory devices.

The processor 61 may process data and/or signals using a program provided from the memory 62, and may transmit a control signal to each component of the refrigerator 1 based on the processing result. For example, the processor 61 may process user input received through the user interface 70, and output values of the door sensor 200 and the object sensor 300, and the Like.

Hereinafter, changing an automatic closing mode and a manual closing mode of the door 30 of the refrigerator 1 and changing an automatic closing condition will be described.

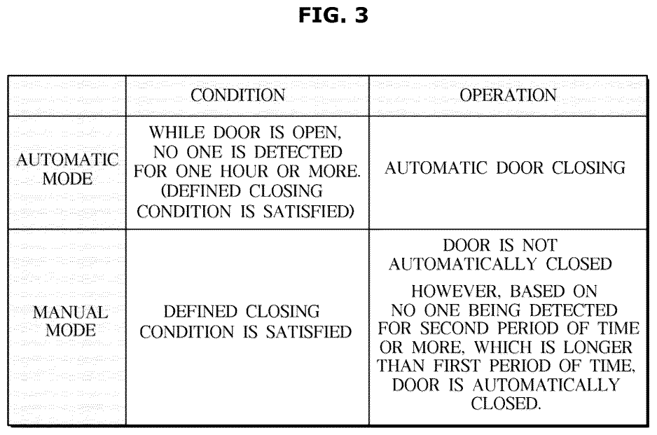

FIG. 3 illustrates automatic and manual closing modes of a door according to an embodiment of the disclosure.

The refrigerator 1 according to the embodiment may automatically close the door 30 when a defined condition (defined closing condition) is satisfied. That is, based on the defined condition being satisfied, the controller 60 may control the door driving device 100 to close the door 30.

Automatically closing the door 30 based on the defined condition being satisfied is referred to as an automatic mode (automatic closing mode).

In the automatic mode, in a case where a first period of time elapses without a person being detected by the object sensor 300 while the door 30 is open, the controller 60 may control the door driving device 100 to close the door 30. Here, the first period of time may be approximately 10 seconds, but is not limited thereto, and may be set to a shorter or longer period of time.

That is, the defined closing condition may include no person being detected by the object sensor 300 for the first period of time or more while the door 30 is open.

On the contrary, a manual mode may refer to a mode in which the door 30 is maintained open, even when the defined closing condition is satisfied.

That is, in the manual mode, even in a case where the first period of time elapses without a person being detected by the object sensor 300 while the door 30 is open, the controller 60 may not control the door 30 to be closed.

However, as will be described below, even in the manual mode, in a case where the door 30 is open and no person is detected by the object sensor 300 for the second period of time or more, which is longer than the first period of time, the controller 60 may control the door driving device 100 to close the door 30 to prevent food in the storage compartment 20 from spoiling due to the door 30 being open for a long time. Here, the second period of time may be set to a period of time from approximately 1 minute to approximately 30 minutes, but is not limited thereto, and may be set to a shorter or longer period of time.

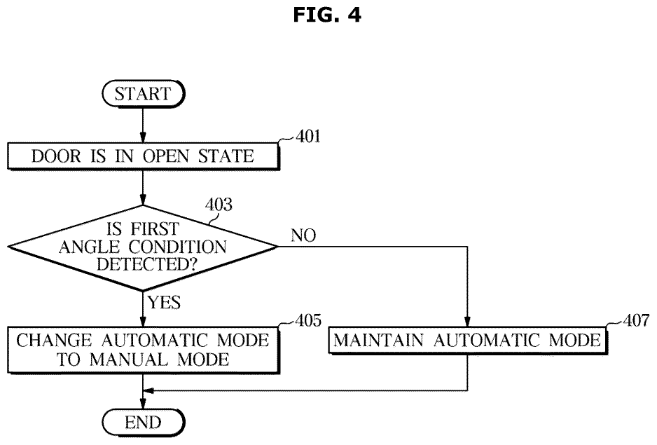

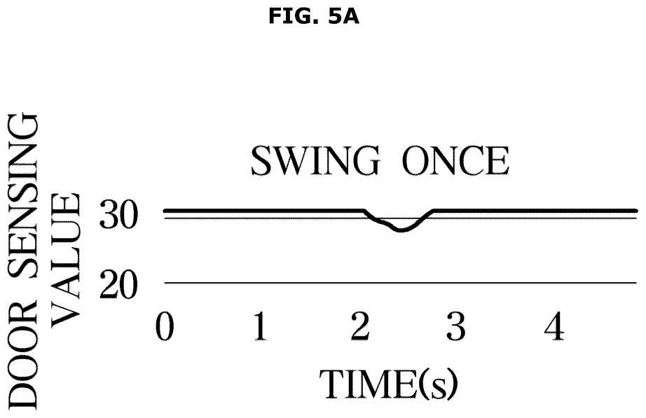

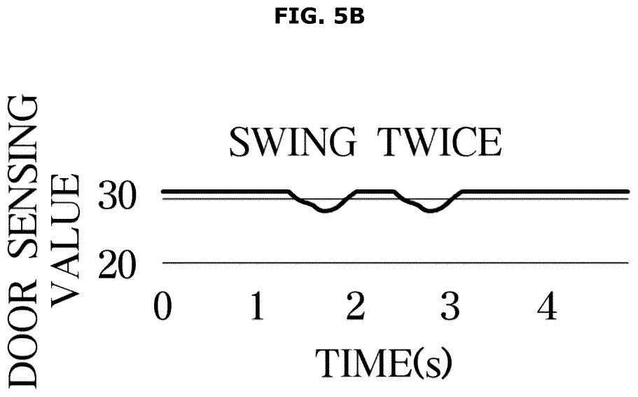

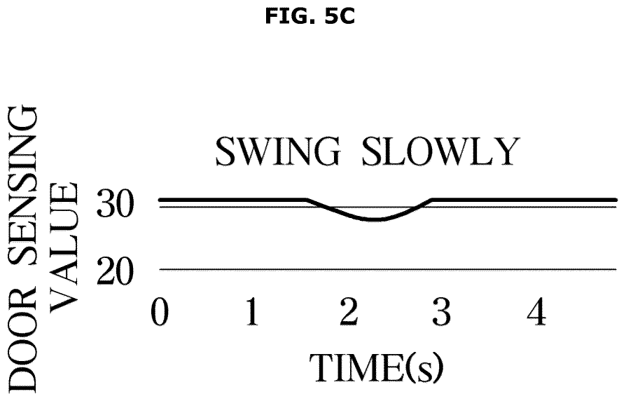

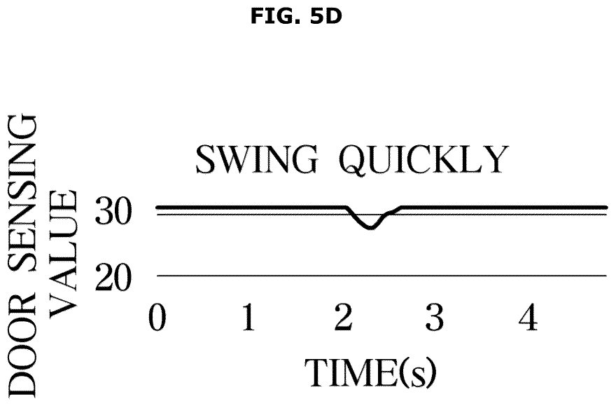

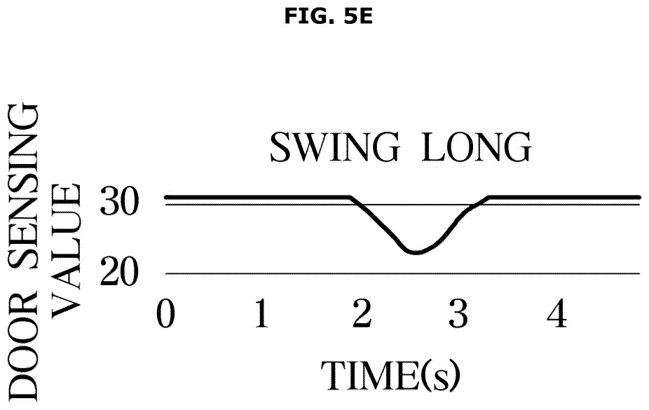

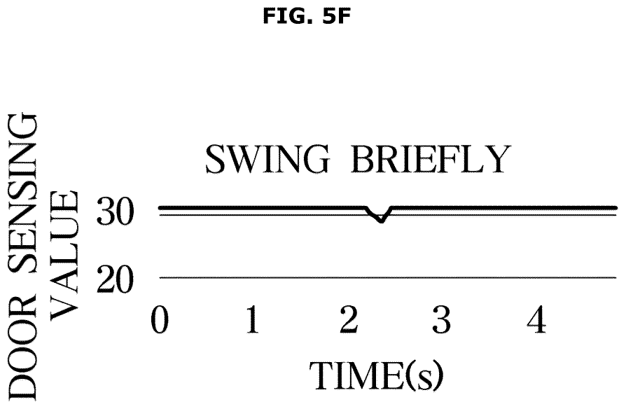

FIG. 4 is a flowchart illustrating a method for controlling a refrigerator according to an embodiment of the disclosure, and FIGS. 5A, 5B, 5C, 5D, 5E, and 5F illustrates various output values of a door sensor according to embodiments of the disclosure. FIG. 5A depicts an output value of a door sensor according to an embodiment of the disclosure. FIG. 5B depicts an output value of a door sensor according to an embodiment of the disclosure. FIG. 5C depicts an output value of a door sensor according to an embodiment of the disclosure. FIG. 5D depicts an output value of a door sensor according to an embodiment of the disclosure. FIG. 5E depicts an output value of a door sensor according to an embodiment of the disclosure. FIG. 5F depicts an output value of a door sensor according to an embodiment of the disclosure.

While the door 30 is in an open state (401), the controller 60 may change the automatic mode to the manual mode (405), based on a first angle condition being detected by the door sensor 200 (Yes in operation 403). In addition, based on the first angle condition not being detected by the door sensor 200 (No in operation 403), the automatic mode may be maintained (407).

Here, the first angle condition may include the number of times that the opening angle of the door 30 has changed by a first reference angle or more being greater than or equal to a reference number of times.

Referring to FIGS. 5A, 5B, 5C, 5D, 5E, and 5F, it may be seen that the door sensor 200 outputs different values as the opening angle of the door 30 changes.

For example, when the door 30 is in a closed state, the door sensor 200 may output a value of 0, and when the door 30 is in a fully open state (approximately 100 degrees), the door sensor 200 may output a value of 31. That is, the output value of the door sensor 200 may increase by approximately 3.2 each time the opening angle of the door 30 increases by 1°.

Referring to FIG. 5B, it may be seen that the number of times the door 30 changes by a defined angle or more is two times. That is, FIG. 5B shows an output value when the door 30 swings twice.

A case where the output value shown in FIG. 5B is obtained may be set as the first angle condition. When two swings of the door 30 are detected, the controller 60 may change the automatic mode to the manual mode.

Accordingly, a user may easily switch between the automatic mode and the manual mode simply by swinging the door 30, thereby increasing user convenience.

However, the first angle condition is not limited thereto, and may be set in various ways according to different changes in the opening angle of the door 30 as shown in FIG. 5A, 5B, 5C, 5D, 5E, AND 5F. Various changes in the opening angle of the door 30 not shown in FIGS. 5A, 5B, 5C, 5D, 5E, and 5F may also be included.

Among various changes in the opening angle of the door 30, the one set as the first angle condition may be preset and stored in the memory 62, or may be separately set or changed by a user input. For example, in a state where the first angle condition is set to changing the opening angle of the door 30 by a reference angle or more twice, as shown in FIG. 5B, a user may change the first angle condition to changing the opening angle of the door 30 by a larger angle once, as shown in FIG. 5E, through a separate input.

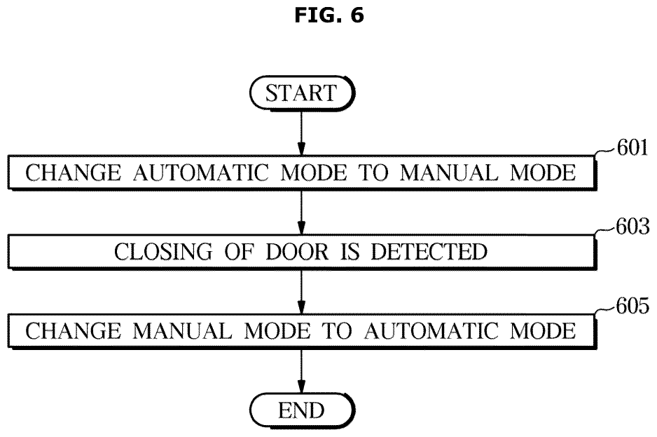

FIG. 6 is a flowchart illustrating operation of changing to an automatic mode as a door is closed according to an embodiment of the disclosure.

As described above, the automatic mode may be changed to the manual mode as the defined condition is satisfied (601).

In this instance, when the closing of the door 30 is detected (603), for example, when a user manually closes the door 30, the controller 60 may change the manual mode back to the automatic mode (605).

Accordingly, when the door 30 is opened again, the door 30 may be automatically closed based on the defined condition being satisfied, thereby increasing user convenience.

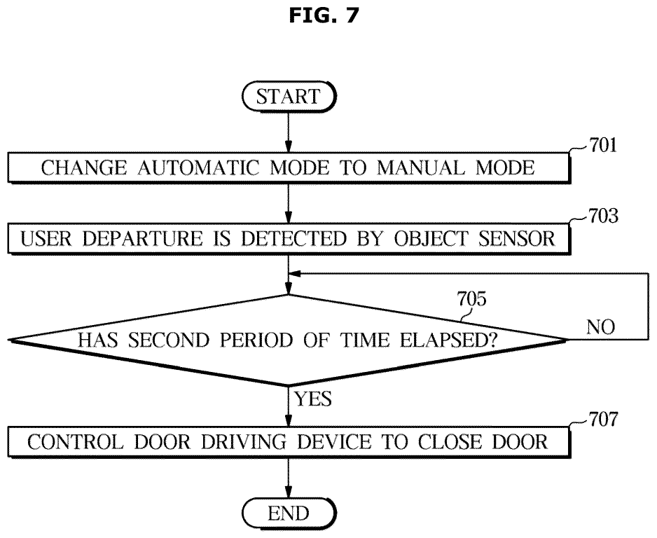

FIG. 7 is a flowchart illustrating operation of automatic door closing in the manual mode according to an embodiment of the disclosure.

As described above, the automatic mode may be changed to the manual mode, when the defined condition is satisfied (701).

In this instance, there may be a case where a user leaves the vicinity of the door 30 without changing the manual mode back to the automatic mode.

In this case, to prevent food in the storage compartment 20 from spoiling, the door 30 may be automatically closed after a defined time elapses. That is, in a case where the user's departure is detected by the object sensor 300 (703) and the second period of time described above elapses (Yes in operation 705), the controller 60 may control the door driving device 100 to close the door 30 (707).

As described above, the second period of time may be set longer than the first period of time that elapses until the door 30 is automatically closed in the automatic mode, and may be set to approximately 1 minute to approximately 30 minutes.

Even in the manual mode, by automatically closing the door 30 when the second period of time, which is longer than the first period of time, elapses to prevent the door 30 from remaining open for an excessively long time, the food storage performance may be improved.

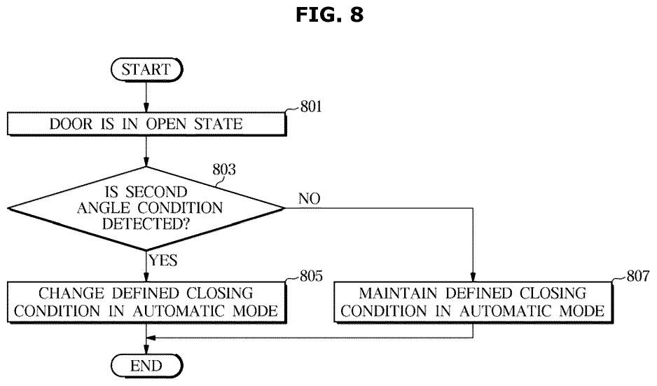

FIG. 8 is a flowchart illustrating operation of changing an automatic door closing condition according to an embodiment of the disclosure.

A user may change the automatic closing mode to the manual closing mode by changing the opening angle of the door 30, and in addition, may change the time required until the door 30 is automatically closed in the automatic mode.

While the door 30 is in an open state (801), the controller 60 may change a defined closing condition in the automatic mode (805), based on a second angle condition being detected by the door sensor 200 (Yes in operation 803). In addition, based on the second angle condition not being detected (No in operation 803), the defined closing condition in the automatic mode may be maintained (807).

In the above description of the automatic mode, when the first period of time elapses without a user being detected by the object sensor 300, the controller 60 may control the door driving device 100 to close the door 30. The user may extend or shorten the first period of time, by moving the door 30 to satisfy the second angle condition.

For example, the second angle condition may include detecting that the opening angle of the door 30 changes by a second reference angle or more, which is greater than the first reference angle, as shown in FIGS. 5A, 5B, 5C, 5D, 5E, AND 5FE.

That is, in a case where the user swings the door 30 by a relatively larger angle, the first period of time required until the door 30 is automatically closed may be extended.

For example, based on detecting that the opening angle of the door 30 changes by the second reference angle or more, which is greater than the first reference angle, the controller 60 may extend the first period of time by 5 seconds. However, the extension time is merely an example and may vary.

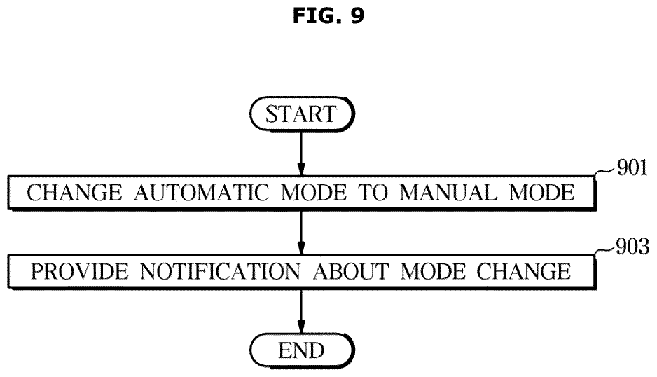

FIG. 9 is a flowchart illustrating operation of providing a notification according to an embodiment of the disclosure.

As described above, the automatic mode may be changed to the manual mode based on the defined condition being satisfied (901), or a defined closing condition for closing the door 30 in the automatic mode may be changed.

In this case, the controller 60 may control the user interface 70 to provide a notification about the mode change (903). In addition, the controller 60 may control the user interface 70 to provide a notification about the change of the defined closing condition.

For example, when the mode is changed, the controller 60 may control the output interface 72 to display a phrase such as “Changed from automatic mode to manual mode.”

In addition, information about the mode change or the change of the defined closing condition may be transmitted to an external device such as a user terminal through the communication circuitry 80.

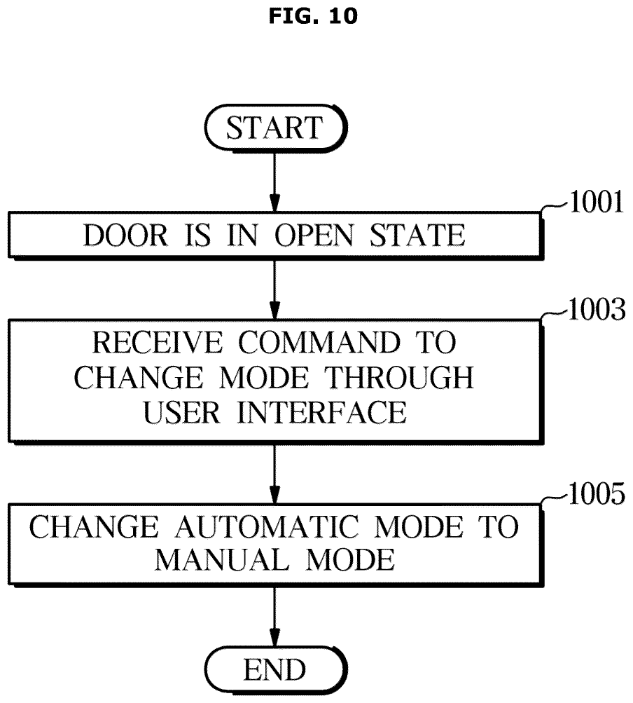

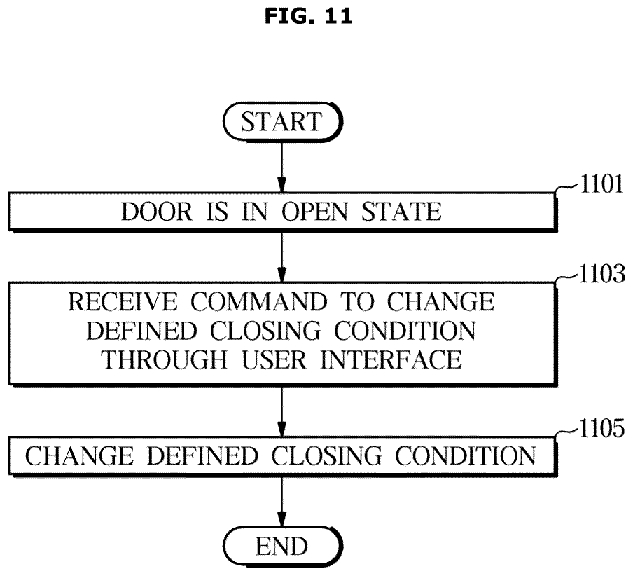

FIG. 10 is a flowchart illustrating operation of changing a door closing mode through the user interface according to an embodiment of the disclosure, and FIG. 11 is a flowchart illustrating operation of changing an automatic door closing condition through the user interface according to an embodiment of the disclosure.

As described above, the refrigerator may include the user interface 70, and the user interface 70 may include an input interface receiving a user input.

In addition to moving the door 30, while the door 30 is in an open state (1001), when a command to change a mode is received (input) from a user through the user interface 70 (1003), the automatic mode may be changed to the manual mode (1005). The mode change may be performed not only when the door 30 is open, but also when it is closed.

For example, the input interface 71 may be implemented as a button, and the user may input a command to change the automatic mode to the manual mode by pressing the button once. However, the above input method is merely an example, and the automatic mode may be changed to the manual mode by various input methods.

In addition, while the door 30 is in an open state (1101), when a command to change a defined closing condition is received from the user through the user interface 70 (1103), the defined closing condition in the automatic mode may be changed (1105). The change of the closing condition may be performed not only when the door 30 is open, but also when it is closed.

For example, the input interface 71 may be implemented as a button, and the user may input a command to extend the first period of time required until the door 30 is automatically closed in the automatic mode by 5 seconds by pressing the button twice.

However, the above input method is merely an example, and the defined closing condition in the automatic mode may be changed by various input methods.

According to an embodiment of the disclosure, a refrigerator may include: a main body forming a storage compartment; a door rotatable to open and close the storage compartment; a door sensor configured to detect an opening angle of the door; a door driving device configured to open and close the door; and a controller configured to: in an automatic mode, control the door driving device to close the door based on a defined closing condition being satisfied, in a manual mode, maintain the door open even based on the defined closing condition being satisfied, and change the automatic mode to the manual mode, based on a first angle condition being detected by the door sensor while the door is open.

According to the disclosure, user convenience may be improved by changing whether to automatically close a door according to the user's intent.

The first angle condition may include a number of times that the opening angle of the door changes by a first reference angle or more being greater than or equal to a reference number of times.

The controller may be configured to change the manual mode to the automatic mode based on the door being closed.

The refrigerator may further include an object sensor configured to detect a person around the door, wherein the defined closing condition may include no person being detected by the object sensor for a first period of time or more while the door is open in the automatic mode.

The refrigerator may further include an object sensor configured to detect a person around the door, wherein the controller may be configured to control the door driving device to close the door, based on no person being detected by the object sensor for a second period of time or more in the manual mode.

The controller may be configured to change the defined closing condition in the automatic mode, based on a second angle condition being detected by the door sensor while the door is open.

The second angle condition may include the opening angle of the door being changed by a second reference angle or more, and the controller may be configured to extend the first period of time, based on the second angle condition being detected by the door sensor while the door is open.

The refrigerator may further include a user interface, wherein the controller may be configured to control the user interface to provide a notification about the change in mode.

The refrigerator may further include a user interface, wherein the controller may be configured to change the automatic mode to the manual mode, based on receiving a command about a mode change via the user interface.

The controller may be configured to change the defined closing condition in the automatic mode, based on receiving a command to change the defined closing condition via the user interface.

According to an embodiment of the disclosure, in a method for controlling a refrigerator including a main body forming a storage compartment; a door rotatable to open and close the storage compartment; a door sensor configured to detect an opening angle of the door; and a door driving device configured to open and close the door, the method may include: detecting whether the door is open; detecting, by the door sensor, a change in the opening angle of the door; and based on a first angle condition being detected by the door sensor, changing an automatic mode to a manual mode, the automatic mode in which the door driving device is controlled to close the door based on a defined closing condition being satisfied, and the manual mode in which the door is maintained open even based on the defined closing condition being satisfied.

The first angle condition may include a number of times that the opening angle of the door changes by a first reference angle or more being greater than or equal to a reference number of times.

The method may further include changing the manual mode to the automatic mode based on the door being closed.

The refrigerator may further include an object sensor configured to detect a person around the door, and the defined closing condition may include no person being detected by the object sensor for a first period of time or more while the door is open in the automatic mode.

The refrigerator may further include an object sensor configured to detect a person around the door, and the method may further include controlling the door driving device to close the door, based on no person being detected by the object sensor for a second period of time or more in the manual mode.

The method may further include changing the defined closing condition in the automatic mode, based on a second angle condition being detected by the door sensor while the door is open.

The second angle condition may include the opening angle of the door being changed by a second reference angle or more, and the changing of the defined closing condition in the automatic mode may include extending the first period of time, based on the second angle condition being detected by the door sensor while the door is open.

The refrigerator may further include a user interface, and the method may further include controlling the user interface to provide a notification about the change in mode.

The refrigerator may further include a user interface, and the changing of the automatic mode to the manual mode may include changing the automatic mode to the manual mode based on receiving a command about a mode change via the user interface.

The method may further include changing the defined closing condition in the automatic mode, based on receiving a command to change the defined closing condition via the user interface.

According to an aspect of the disclosure, user convenience may be improved by changing whether to automatically close a door according to the user's intent.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

1. A refrigerator, comprising:
a main body forming a storage compartment;
a door rotatably coupled to the main body and configured to open and configured to close the storage compartment;
a door sensor configured to detect opening of the door at an angle relative to the main body;
a door driving device configured to open and configured to close the door; and
a controller configured to:
control the door driving device to close the door based on a condition to close the door being satisfied in an automatic mode,
maintain the opening of the door at the angle relative to the main body based on the condition to close the door being satisfied in a manual mode, and
change the automatic mode to the manual mode, based on the door sensor detecting the opening of the door being at the angle relative to the main body.

2. The refrigerator of claim 1, wherein the angle relative to the main body satisfies a first angle condition, the first angle condition including a number of times that the angle relative to the main body changes by a first reference angle or a reference angle greater than the first reference angle being greater than or equal to a reference number of times.

3. The refrigerator of claim 1, wherein the controller is configured to change the manual mode to the automatic mode based on detecting the door being closed.

4. The refrigerator of claim 1, further comprising:
an object sensor configured to detect a person,
wherein the condition includes no person being detected by the object sensor for a first period of time or more based on the door being open in the automatic mode.

5. The refrigerator of claim 1, further comprising:
an object sensor configured to detect a person,
wherein the controller is configured to control the door driving device to close the door, based on no person being detected by the object sensor for a second period of time or more in the manual mode.

6. The refrigerator of claim 4, wherein the controller is configured to change the condition in the automatic mode, based on a second angle condition being detected by the door sensor based on the door being open.

7. The refrigerator of claim 6, wherein the second angle condition includes the angle relative to the main body being changed by a second reference angle or more, and
the controller is configured to extend the first period of time, based on the second angle condition being detected by the door sensor based on the door being open.

8. The refrigerator of claim 1, further comprising:
a user interface,
wherein the controller is configured to control the user interface to provide a notification about a mode change.

9. The refrigerator of claim 1, further comprising:
a user interface,
wherein the controller is configured to change the automatic mode to the manual mode, based on receiving a command about a mode change via the user interface.

10. The refrigerator of claim 9, wherein the controller is configured to change the condition in the automatic mode, based on receiving a command to change the condition via the user interface.

11. A method for controlling a refrigerator comprising:
detecting a door, the door being rotatably connected to a main body forming a storage compartment and the door is configured to open and configured to close the storage compartment, is open;
detecting, by a door sensor configured to detect an opening of the door at angle relative to the main body, a change in the angle relative to the main body; and
based on the opening of the door at the angle relative to the main body being detected by the door sensor changing an automatic mode of a door driving device configured to open and configured close the door, to a manual mode of the door driving device, wherein in the automatic mode, the door driving device is controlled to close the door based on a condition being satisfied, and in the manual mode, the door is maintained open based on the condition being satisfied.

12. The method of claim 11, wherein the angle relative to the main body satisfies a first angle condition, the first angle condition including a number of times that the angle relative to the main body changes by a first reference angle or a reference angle greater than the first reference angle being greater than or equal to a reference number of times.

13. The method of claim 11, further comprising:
changing the manual mode to the automatic mode based on detecting the door being closed.

14. The method of claim 11, wherein the refrigerator further comprises an object sensor configured to detect a person, and
the condition includes no person being detected by the object sensor for a first period of time or more based on the door being open in the automatic mode.

15. The method of claim 11, wherein the refrigerator further comprises an object sensor configured to detect a person, and
the method further comprises controlling the door driving device to close the door, based on no person being detected by the object sensor for a second period of time or more in the manual mode.
